(19) United States
(12) Patent Application Publication
(10) Pub. No.: US 2013/0126743 A1
(43) Pub. Date: May 23, 2013

(54) RADIATION DETECTOR

(71) Applicant: Fujifilm Corporation, Tokyo (JP)

(72) Inventors: Naoto IWAKIRI, Ashigarakami-gun (JP); Haruyasu NAKATSUGAWA, Ashigarakami-gun (JP); Naoyuki NISHINOU, Ashigarakami-gun (JP); Yasunori OHTA, Ashigarakami-gun (JP)

(73) Assignee: FUJIFILM CORPORATION, Tokyo (JP)

(21) Appl. No.: 13/744,433

(22) Filed: Jan. 18, 2013

Related U.S. Application Data
(63) Continuation of application No. PCT/JP2011/066927, filed on Jul. 26, 2011.

(30) Foreign Application Priority Data
Jul. 26, 2010 (JP) 2010-167489

(51) Int. Cl. G01T 1/20

(52) U.S. Cl. CPC G01T 1/2006
USPC 250/366

(57) ABSTRACT

A radiation detector includes a scintillator layer, a first photoelectric conversion layer, a second photoelectric conversion layer, and one board or two boards. The scintillator layer, the first photoelectric conversion layer, the second photoelectric conversion layer, and the one board or two boards are layered. The first photoelectric conversion layer is constituted with one of a first organic material and an inorganic material with a wider radiation absorption wavelength range than the first organic material. The first photoelectric conversion layer absorbs at least light of a first wavelength and converts the light to charges. The second photoelectric conversion layer is constituted with a second organic material that is different from the first organic material. The second photoelectric conversion layer absorbs more of light of a second wavelength than of light of the first wavelength and converts the light to charges.

This application is a continuation application of International Application No. PCT/JP2011/066927, filed Jul. 26, 2011, which is incorporated herein by reference. Further, this application claims priority from Japanese Patent Application No. 2010-167489, filed Jul. 26, 2010, which is incorporated herein by reference.

### BACKGROUND OF THE INVENTION

1. Technical Field

The present invention relates to a radiation detector.

2. Related Art

In recent years, radiation detectors such as flat panel detectors (FPD) and the like have been realized. In an FPD, an X-ray-sensitive layer is disposed on a thin film transistor (TFT) active matrix substrate, and the FPD is capable of converting X-ray information directly to digital data. These radiation detectors have advantages over related art imaging plates in that images can be checked immediately and video images can be checked, and are rapidly becoming widely used.

Various types of this kind of radiation detector have been proposed. For example, there are direct conversion types in which X-rays are directly converted to electronic charges in a semiconductor layer and the charges are accumulated, and indirect conversion types in which X-rays are converted to light by a scintillator (a wavelength conversion component) of CsI:Tl, GOS (Gd₂O₂S:Tb) or the like, the converted light is converted to electronic charges by light detection sensors such as photodiodes or the like, and the charges are accumulated.

A technology is known in which, in imaging of a radiographic image, the same location of an imaging subject is imaged with different X-ray tube voltages and image processing is applied that applies weightings to the radiation images obtained with the respective X-ray tube voltages and calculates differences therebetween (referred to hereinafter as “subtraction image processing”). Thus, a radiation image is obtained in which one of an image portion corresponding to hard tissues such as bones and the like and an image portion corresponding to soft tissues is emphasized in the image and the other is removed (hereinafter referred to as an “energy subtraction image”). For example, when an energy subtraction image corresponding to soft tissues in the chest area is used, pathology that is concealed by the ribs may be made visible, and diagnostic performance may be improved.

However, when images are captured with different X-ray tube voltages, there are two irradiations of radiation. Therefore, there is a risk that an image that is good for diagnostic performance may not be obtained if the body of the imaging subject moves or the like.

Accordingly, Patent Document 1 (Japanese National Publication No. 2009-511871) discloses a radiation detector that may, by irradiating radiation once, obtain two kinds of radiation image, an image of soft tissues expressed by low-energy radiation of the radiation passing through the imaging subject (hereinafter referred to as a “low-voltage image”) and an image of hard tissues expressed by high-energy radiation (hereinafter referred to as a “high-voltage image”).

In concrete terms, this radiation detector is structured by a first scintillator layer, a second scintillator layer, a first photoelectric conversion layer and a second photoelectric conversion layer being layered in this order. The first scintillator layer absorbs radiation and converts the radiation to light with a first wavelength. The second scintillator layer absorbs radiation and converts the radiation to light with a second wavelength. The first photoelectric conversion layer does not respond to light of the first wavelength but does respond to (photoelectrically converts) light of the second wavelength. The second photoelectric conversion layer does not respond to light of the second wavelength but does respond to (photoelectrically converts) light of the first wavelength.

However, in the configuration of Patent Document 1, because there is a radiation sensitive surface at the first scintillator layer side of the radiation detector, the irradiated radiation passes through the first scintillator layer, the second scintillator layer, the first photoelectric conversion layer and the second photoelectric conversion layer in this order from the radiation sensitive surface. Therefore, a distance from a scintillator region of the first scintillator layer at the radiation sensitive surface side, which region primarily absorbs radiation and emits light, to the first photoelectric conversion layer is almost the same as the sum of the thickness of the first scintillator layer and the thickness of the second scintillator layer, which is a large distance. Accordingly, received light amounts at the first photoelectric conversion layer of the light emitted from the first scintillator layer are reduced. The same problem applies to the second photoelectric conversion layer. Therefore, when received light amounts of the first photoelectric conversion layer and the second photoelectric conversion layer are reduced, the image quality of a radiation image that is obtained by imaging is adversely affected.

### SUMMARY

The present invention has been made in view of the above circumstances, and an object of the present invention is to provide a radiation detector capable of increasing received light amounts received by photoelectric conversion layers.

A radiation detector according to a first aspect of the present invention includes: a scintillator layer in which a first fluorescent material and a second fluorescent material are in separate layers or are mixed in a single layer, the first fluorescent material responding primarily to radiation of a first energy in irradiated radiation and converting the radiation to light of a first wavelength, and the second fluorescent material responding primarily to radiation of a second energy that is different from the first energy in the irradiated radiation and converting the radiation to light of a second wavelength that is different from the first wavelength; a first photoelectric conversion layer that is disposed at a side of irradiation of the radiation relative to the scintillator layer including the first fluorescent material, the first photoelectric conversion layer being constituted with one of a first organic material and an inorganic material with a wider radiation absorption wavelength range than the first organic material, and the first photoelectric conversion layer absorbing at least light of the first wavelength and converting the light to charges; a second photoelectric conversion layer that is constituted with a second organic material that is different from the first organic material, the second photoelectric conversion layer absorbing more of light of the second wavelength than of light of the first wavelength and converting the light to charges; and one board or two boards, at which transistors that read out charges generated at the first photoelectric conversion layer and the second photoelectric conversion layer are formed.

According to this configuration, when radiation that has passed through the imaging subject is irradiated, the first fluorescent material of the scintillator layer primarily responds to radiation of the first energy in the irradiated radiation and converts this radiation to light of the first wavelength, and the second fluorescent material of the scintillator layer primarily responds to radiation of the second energy, which is different from the first energy, in the irradiated radiation and converts this radiation to light of the second wavelength. Then, a radiation image of the imaging subject expressed by the radiation of the first energy is obtained by the first photoelectric conversion layer absorbing at least the light of the first wavelength from the scintillator layer and converting this light to electric charges, and a radiation image of the imaging subject expressed by the radiation of the second energy is obtained by the second photoelectric conversion layer absorbing the light of the second wavelength from the scintillator layer in larger amounts than the light of the first wavelength and converting this light to charges.

Thus, two kinds of radiation image, a radiation image of the imaging subject expressed by radiation of the first energy and a radiation image of the imaging subject expressed by radiation of the second energy, may be obtained by one irradiation of the radiation.

Because the first photoelectric conversion layer is disposed at the radiation irradiation side relative to the scintillator layer containing the first fluorescent material, of the scintillator layer containing the first fluorescent material, a scintillator region that is at the first photoelectric conversion layer side thereof is irradiated first. Therefore, the scintillator region at the first photoelectric conversion layer side primarily absorbs the radiation and emits light of the first wavelength.

If the scintillator region that primarily absorbs the radiation and emits light of the first wavelength is at the first photoelectric conversion layer side in the scintillator layer containing the first fluorescent material, the distance between this scintillator region and the first photoelectric conversion layer that absorbs the light of the first wavelength is shorter than in an opposite arrangement of the first photoelectric conversion layer and the scintillator layer by an amount corresponding to the thickness of the scintillator layer.

As a result, received light amounts of the light with the first wavelength, which is emitted from the first fluorescent material primarily responding to the radiation of the first energy, that are received at the first photoelectric conversion layer are increased.

In a radiation detector according to a second aspect of the present invention, in the first aspect, the first energy is a smaller energy than the second energy, and the first photoelectric conversion layer is constituted with the first organic material, absorbs more of light of the first wavelength than of light of the second wavelength, and converts the light to charges.

According to this configuration, the first photoelectric conversion layer absorbs light of the first wavelength from the scintillator layer in larger amounts than light of the second wavelength and converts this light to charges, thus providing a low-voltage image of soft tissues of the imaging subject expressed by the radiation of the first energy, which is smaller than the second energy. The second photoelectric conversion layer absorbs light of the second wavelength from the scintillator layer in larger amounts than light of the first wavelength and converts this light to charges, thus providing a high-voltage image of hard tissues of the imaging subject expressed by the radiation of the second energy, which is larger than the first energy.

Further, because the first photoelectric conversion layer is disposed at the radiation irradiation side relative to the scintillator layer containing the first fluorescent material, a high image quality low-voltage image of the imaging subject expressed by the radiation of the first energy can be obtained. Because soft tissues are generally more finely structured than hard tissues, it is more useful for a low-voltage image to have high image quality than a high-voltage image in the respect that finely structured regions of soft tissues may be reliably viewed.

Because the first photoelectric conversion layer absorbs the light of the first wavelength from the scintillator layer in larger amounts than the light of the second wavelength, differentiation between the obtained low-voltage image and high-voltage image is clearer.

Furthermore, because the first photoelectric conversion layer is constituted with the first organic material, an absorption proportion of the radiation is generally very low compared with a case of constitution with an inorganic material. Therefore, even though the first photoelectric conversion layer is disposed at the radiation irradiation side relative to the scintillator layer containing the first fluorescent material, a large proportion of the radiation is incident on the scintillator layer and a reduction in light emission amounts from the scintillator layer may be suppressed. Hence, reductions in received light amounts at the first photoelectric conversion layer and the second photoelectric conversion layer may be suppressed.

In a radiation detector according to a third aspect of the present invention, in the second aspect, the scintillator layer is a single layer in which the first fluorescent material and the second fluorescent material are mixed, the boards are constituted by two boards, one board of which reads out charges generated at the first photoelectric conversion layer and the other board of which reads out charges generated at the second photoelectric conversion layer, the one board serving as a radiation irradiated surface, and, from a side at which the one board is disposed, the first photoelectric conversion layer, the scintillator layer, the second photoelectric conversion layer and the other board are layered in this order.

According to this configuration, the irradiated radiation is incident on the one board, the first photoelectric conversion layer, the scintillator layer, the second photoelectric conversion layer and the other board, in this order.

Here, the scintillator layer is formed as a single layer in which the first fluorescent material and the second fluorescent material are mixed. Of the radiation incident on the scintillator layer, the radiation of the first energy, which is smaller than the second energy, generally tends to be absorbed more by the scintillator region at the radiation irradiation side of the scintillator layer. Of the radiation incident on the scintillator layer, the radiation of the second energy, which is larger than the first energy, generally tends to be absorbed more by a scintillator region at the opposite side of the scintillator layer from the radiation irradiation side thereof.

Therefore, smaller amounts of the radiation of the first energy than of the radiation of the second energy are incident on the scintillator region at the opposite side from the radiation irradiation side. Consequently, at the scintillator region at the opposite side from the radiation irradiation side, light emission amounts of light of the second wavelength from the second fluorescent material are larger than light emission amounts of light of the first wavelength from the first fluorescent material. Thus, the second photoelectric conversion layer that is layered next after the scintillator layer as seen from the radiation irradiation side receives larger amounts of light of the second wavelength than of light of the first wavelength. Thus, a high-voltage image with little noise may be obtained.

In a radiation detector according to a fourth aspect of the present invention, in the third aspect, more of the first fluorescent material than of the second fluorescent material is mixed at the first photoelectric conversion layer side of the scintillator layer, and more of the second fluorescent material than of the first fluorescent material is mixed at the second photoelectric conversion layer side of the scintillator layer.

According to this configuration, in the scintillator region at the first photoelectric conversion layer side of the scintillator layer, larger amounts of the first fluorescent material than the second fluorescent material are mixed in. Therefore, light of the first wavelength is primarily emitted. In the scintillator region at the second photoelectric conversion layer side of the scintillator layer, larger amounts of the second fluorescent material than the first fluorescent material are mixed in. Therefore, light of the second wavelength is primarily emitted.

Consequently, at the first photoelectric conversion layer, received light amounts of light of the first wavelength are larger than received light amounts of light of the second wavelength by amounts corresponding to the amount by which the distance from the scintillator region that primarily emits light of the first wavelength, which is at the first photoelectric conversion layer side, is shorter than the distance from the scintillator region that primarily emits light of the second wavelength, which is at the second photoelectric conversion layer side. Thus, a low-voltage image with little noise may be obtained.

Moreover, at the second photoelectric conversion layer, received light amounts of light of the second wavelength are larger than received light amounts of light of the first wavelength by amounts corresponding to the amount by which the distance from the scintillator region that primarily emits light of the second wavelength, which is at the second photoelectric conversion layer side, is shorter than the distance from the scintillator region that primarily emits light of the first wavelength, which is at the first photoelectric conversion layer side. Thus, a high-voltage image with little noise may be obtained.

In a radiation detector according to a fifth aspect of the present invention, in the second aspect, the boards are constituted by two boards, one board of which reads out charges generated at the first photoelectric conversion layer and the other board of which reads out charges generated at the second photoelectric conversion layer, the one board serving as a radiation irradiated surface, the scintillator layer is constituted by separate layers, one scintillator layer of the separate layers being constituted with the first fluorescent material and another scintillator layer of the separate layers being constituted with the second fluorescent material, and, from a side at which the one board is disposed, the first photoelectric conversion layer, the one scintillator layer, the other scintillator layer, the second photoelectric conversion layer and the other board are layered in this order.

According to this configuration, when the radiation is incident, the one scintillator layer emits light of the first wavelength and the other scintillator layer emits light of the second wavelength.

The first photoelectric conversion layer receives light amounts of light of the first wavelength that are larger than received light amounts of light of the second wavelength by amounts corresponding to the amount by which the distance from the one scintillator layer that emits light of the first wavelength, which is at the first photoelectric conversion layer side, is shorter than the distance from the other scintillator layer that emits light of the second wavelength, which is at the second photoelectric conversion layer side. Thus, a low-voltage image with little noise may be obtained.

The second photoelectric conversion layer receives light amounts of light of the second wavelength that are larger than received light amounts of light of the first wavelength by amounts corresponding to the amount by which the distance from the other scintillator layer that emits light of the second wavelength, which is at the second photoelectric conversion layer side, is shorter than the distance from the one scintillator layer that emits light of the first wavelength, which is at the first photoelectric conversion layer side. Thus, a high-voltage image with little noise may be obtained.

In a radiation detector according to a sixth aspect of the present invention, in the second aspect, the scintillator layer is a single layer in which the first fluorescent material and the second fluorescent material are mixed, the board is a radiation irradiated surface, and, from a side at which the board is disposed, the first photoelectric conversion layer, the second photoelectric conversion layer and the scintillator layer are layered in this order, or the second photoelectric conversion layer, the first photoelectric conversion layer and the scintillator layer are layered in this order.

According to this configuration, the irradiated radiation is incident on the board, the first photoelectric conversion layer, the second photoelectric conversion layer and the scintillator layer in this order, or on the board, the second photoelectric conversion layer, the first photoelectric conversion layer and the scintillator layer in this order. When the radiation is incident on the scintillator layer, the scintillator region at the radiation irradiation side of the scintillator layer primarily emits light. Therefore, light of the first wavelength may be received at the first photoelectric conversion layer in amounts that are larger by amounts corresponding to the amount by which the distance between the radiation irradiation side scintillator region and the first photoelectric conversion layer is shorter.

In this structure, the radiation is incident on the first photoelectric conversion layer and the second photoelectric conversion layer before being incident on the scintillator layer. However, because the first photoelectric conversion layer is constituted with the first second organic material, an absorption proportion of the radiation is generally very low compared to a case of constitution with an inorganic material. Therefore, even though the first photoelectric conversion layer and second photoelectric conversion layer are layered at the radiation irradiation side relative to the scintillator layer, a large proportion of the radiation reaches the scintillator layer and a reduction in light emission amounts from the scintillator layer may be suppressed. Hence, a deterioration in image quality may be suppressed.

In a radiation detector according to a seventh aspect of the present invention, in the first aspect, the first energy is greater than the second energy, the first photoelectric conversion layer is constituted with the first organic material, absorbs more of light of the first wavelength than of light of the second wavelength, and converts the light to charges, the scintillator layer is constituted by separate layers, one scintillator layer of the separate layers is constituted with the second fluorescent material and serves as a radiation irradiated surface, another scintillator layer of the separate layers is constituted with the first fluorescent material, and, from a side at which the one scintillator layer is disposed, the second photoelectric conversion layer, the board, the first photoelectric conversion layer, and the other scintillator layer are layered in this order.

According to this configuration, the second photoelectric conversion layer absorbs larger amounts of light of the second wavelength from the one scintillator layer than of light of the first wavelength from the other scintillator layer, and converts the light to charges. Thus, a low-voltage image expressed by radiation of the second energy, which is smaller than the first energy, is obtained. Meanwhile, the first photoelectric conversion layer absorbs larger amounts of light of the first wavelength from the other scintillator layer than of light of the second wavelength from the one scintillator layer, and converts the light to charges. Thus, a high-voltage image expressed by radiation of the first energy, which is larger than the second energy, is obtained.

Because the first photoelectric conversion layer is disposed at the radiation irradiation side relative to the other scintillator layer constituted with the first fluorescent material, the distance between a scintillator region that primarily emits light in the other scintillator layer and the first photoelectric conversion layer is shortened. Hence, a high image quality high-voltage image of the imaging subject expressed by the radiation of the first energy may be obtained.

Generally, a scintillator layer emits light in light emission amounts that are larger for radiation that is directly incident than for radiation passing through a photoelectric conversion layer and a board or the like, by amounts corresponding to the absence of the possibility of the radiation being absorbed. If, for example, the thickness of the one scintillator layer is increased, the distance between a scintillator region in the one scintillator layer that primarily emits light and the second photoelectric conversion layer becomes longer. However, the thickness of the one scintillator layer at the second photoelectric conversion layer side may be reduced by an amount corresponding to the provision of the other scintillator layer at the first photoelectric conversion layer side, which is at a non-irradiated face side relative to the second photoelectric conversion layer. Then, if the thickness of the one scintillator layer is reduced, the distance between the scintillator region in the one scintillator layer that primarily absorbs radiation and emits light and the second photoelectric conversion layer is reduced, and received light amounts of light of the second wavelength received by the second photoelectric conversion layer increase. Hence, a high image quality low-voltage image of the imaging subject expressed by radiation of the second energy may be obtained.

In a radiation detector according to an eighth aspect of the present invention, in the first aspect, the first energy is greater than the second energy, the first photoelectric conversion layer is constituted with the inorganic material, the scintillator layer is constituted by separate layers, one scintillator layer of the separate layers is constituted with the second fluorescent material and serves as a radiation irradiated surface, another scintillator layer of the separate layers is constituted with the first fluorescent material, and, from a side at which the one scintillator layer is disposed, the second photoelectric conversion layer, the board, the first photoelectric conversion layer, and the other scintillator layer are layered in this order.

According to this configuration, the first photoelectric conversion layer absorbs at least light of the first wavelength from the other scintillator layer and converts the light to charges, thus providing a high-voltage image expressed by radiation of the first energy, which is larger than the second energy. Meanwhile, the second photoelectric conversion layer absorbs larger amounts of light with the second wavelength from the one scintillator layer than of light with the first wavelength from the other scintillator layer and converts the light to charges, thus providing a low-voltage image expressed by radiation of the second energy, which is smaller than the first energy.

Because the first photoelectric conversion layer is disposed at the radiation irradiation side relative to the other scintillator layer constituted with the first fluorescent material, a high image quality high-voltage image of the imaging subject expressed by the radiation of the first energy can be obtained.

Further, because the first photoelectric conversion layer is constituted with an inorganic material with a wider wavelength absorption range of radiation than the first organic material, scope for selection of the first fluorescent material constituting the other scintillator layer may be broadened.

In a radiation detector according to a ninth aspect of the present invention, in the seventh or eighth aspect, a color filter disposed one of between the first photoelectric conversion layer and the board and between the second photoelectric conversion layer and the board is provided, the color filter absorbing light from one of the one scintillator layer and the other scintillator layer.

According to this configuration, even if light of the first wavelength as well as light of the second wavelength is included in light emitted from the one scintillator (the second fluorescent material), because the color filter preceding the first photoelectric conversion layer absorbs this light of the first wavelength, excess absorption by the first photoelectric conversion layer of light of the first wavelength from the second fluorescent material may be suppressed. Alternatively, even if light of the second wavelength as well as light of the first wavelength is included in light emitted from the other scintillator (the first fluorescent material), because the color filter preceding the second photoelectric conversion layer absorbs this light of the second wavelength, excess absorption by the second photoelectric conversion layer of light of the second wavelength from the first fluorescent material may be suppressed.

In a radiation detector according to a tenth aspect of the present invention, in any one of the first to ninth aspects, the first photoelectric conversion layer transmits light of the second wavelength and absorbs light of the first wavelength, and the second photoelectric conversion layer transmits light of the first wavelength and absorbs light of the second wavelength.

According to this configuration, the first photoelectric conversion layer transmits and does not absorb light of the second wavelength from the scintillator layer, but absorbs light of the first wavelength and converts this light to charges. Thus, a radiation image expressed by radiation of the first energy may be distinctly obtained in a form that does not contain a radiation image expressed by radiation of the second energy. The second photoelectric conversion layer transmits and does not absorb light of the first wavelength from the scintillator layer, but absorbs light of the second wavelength and converts this light to charges. Thus, a radiation image expressed by radiation of the second energy may be distinctly obtained in a form that does not contain a radiation image expressed by radiation of the first energy.

In a radiation detector according to an eleventh aspect of the present invention, in any one of the first to tenth aspects, the first wavelength is a wavelength of blue light and the second wavelength is a wavelength of green light.

Here, depending on the selection of the first fluorescent material and the second fluorescent material (more specifically, activator agents), the first wavelength may be a wavelength of green light and the second wavelength may be a wavelength of blue light.

Thus, by the colors of the light of the first wavelength and the light of the second wavelength emitted by the scintillator layer being divided, an overlap between the light emission wavelength ranges of the lights may be avoided, and the generation of noise may be suppressed.

In a radiation detector according to a twelfth aspect of the present invention, in any one of the second to seventh aspects, an active layer of the transistors is constituted with a non-crystalline oxide, and the board is constituted with a plastic resin.

According to this configuration, because the first photoelectric conversion layer is constituted by the first organic material, the second photoelectric conversion layer is constituted by the second organic material and the active layers of the transistors are constituted by the non-crystalline oxide, the radiation detector may be fabricated with all processes being at low temperatures. Thus, the board may generally have a lower heat resistance, and may be constituted by a plastic resin with flexibility. If a board of such a plastic resin is used, weight may be reduced, which is advantageous to, for example, portability and the like.

According to the present invention, a radiation detector capable of increasing received light amounts received by photoelectric conversion layers may be provided.

### BRIEF DESCRIPTION OF THE DRAWINGS

FIG. 1 is a schematic view illustrating the disposition of an electronic cassette during imaging of a radiation image;

FIG. 2 is a schematic perspective diagram illustrating internal structure of the electronic cassette;

FIG. 3 is a sectional diagram showing sectional structure of a radiation detector in accordance with a first exemplary embodiment of the present invention;

FIG. 4 is a graph showing relationships between wavelength and spectral characteristics.

FIG. 5 is a sectional diagram showing detailed structure of the radiation detector shown in FIG. 3;

FIG. 6 is a diagram schematically showing the structure of a TFT switch;

FIG. 7 is a diagram showing wiring structure of a TFT circuit board;

FIG. 8 is a diagram describing operation of the radiation detector in accordance with the first exemplary embodiment of the present invention;

FIG. 9 is a sectional diagram showing the sectional structure of a radiation detector in accordance with a second exemplary embodiment of the present invention;

FIG. 10 is a sectional diagram showing the sectional structure of a radiation detector in accordance with a third exemplary embodiment of the present invention;

FIG. 11 is a sectional diagram showing the sectional structure of a radiation detector in accordance with a fourth exemplary embodiment of the present invention;

FIG. 12 is a sectional diagram showing the sectional structure of a radiation detector in accordance with a fifth exemplary embodiment of the present invention;

FIG. 13A is a graph showing a relationship between mixing amounts of a first fluorescent material and distances in a direction of thickness of a scintillator layer;

FIG. 13B is a graph showing relationships between radiation absorption amounts and distances in the scintillator layer thickness direction; and

FIG. 14 is a diagram showing a variant example of the radiation detector in accordance with the second exemplary embodiment of the present invention.

### DETAILED DESCRIPTION OF THE INVENTION

### First Exemplary Embodiment

Herebelow, a radiation detector according to a first exemplary embodiment of the present invention is specifically described while referring to the attached drawings. In the drawings, members (structural elements) with the same or corresponding functions are assigned the same reference numerals, and descriptions thereof are omitted as appropriate.

Structure of Radiation Image Capturing Device

First, structure of an electronic cassette that is an example of a radiation image capturing device incorporating the radiation detector according to the first exemplary embodiment of the present invention is described.

The electronic cassette according to the first exemplary embodiment of the invention is a radiation image capturing device that is portable, detects radiation that has passed through an imaging subject from a radiation source, generates image information of a radiation image expressed by the detected radiation, and may memorize the generated image information. In concrete terms, the electronic cassette is structured as described below. The electronic cassette may have a structure in which the generated image information is not memorized therein.

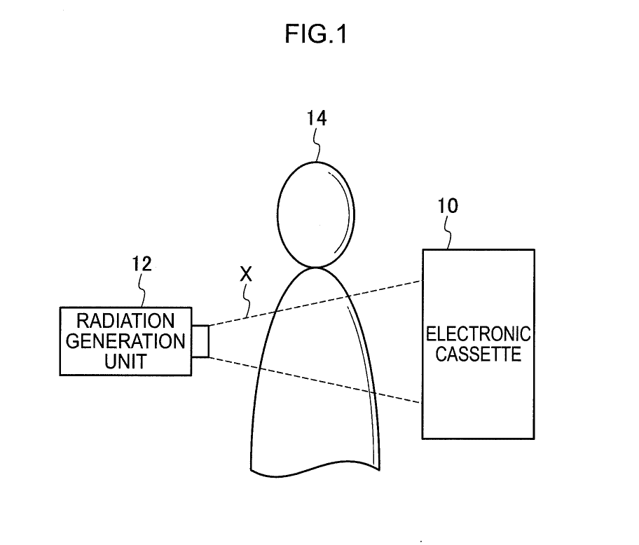

FIG. 1 is a schematic view illustrating disposition of the electronic cassette during imaging of a radiation image.

At a time of imaging of a radiographic image, an electronic cassette 10 is disposed to be spaced from a radiation generation unit 12 that serves as a radiation source generating radiation X. The gap between the radiation generation unit 12 and the electronic cassette 10 at this time serves as an imaging position in which a patient 14 who is an imaging subject is disposed. When imaging of the radiation image is instructed, the radiation generation unit 12 emits the radiation X in radiation amounts according to radiation conditions given beforehand and suchlike. The radiation X emitted from the radiation generation unit 12 passes through the patient 14 disposed at the imaging position and, carrying image information, is then irradiated onto the electronic cassette 10.

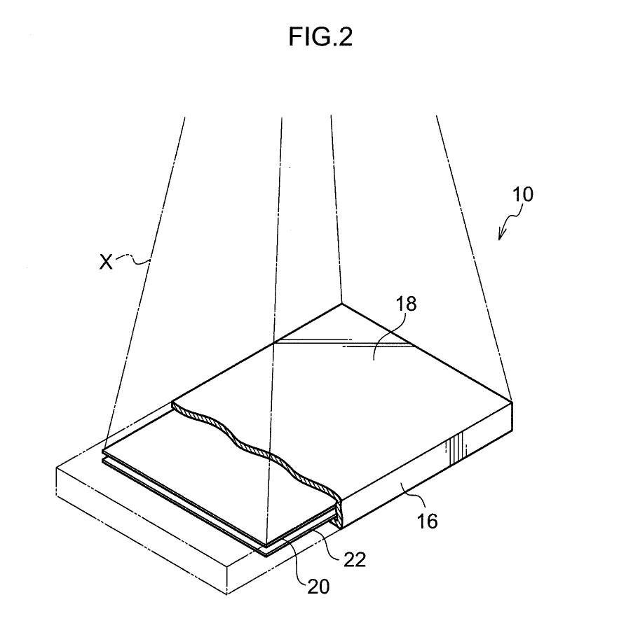

FIG. 2 is a schematic perspective diagram illustrating internal structure of the electronic cassette 10.

The electronic cassette 10 is equipped with a casing 16 in a flat plate shape with a predetermined thickness, formed of a material that transmits the radiation X. Inside the casing 16, a radiation detector 20 and a control board 22 are provided in this order from the side of the casing 16 at which an irradiated surface 18 on which the radiation X is irradiated is disposed. The radiation detector 20 detects the radiation X that has passed through the patient 14, and the control board 22 controls the radiation detector 20.

Structure of the Radiation Detector 20

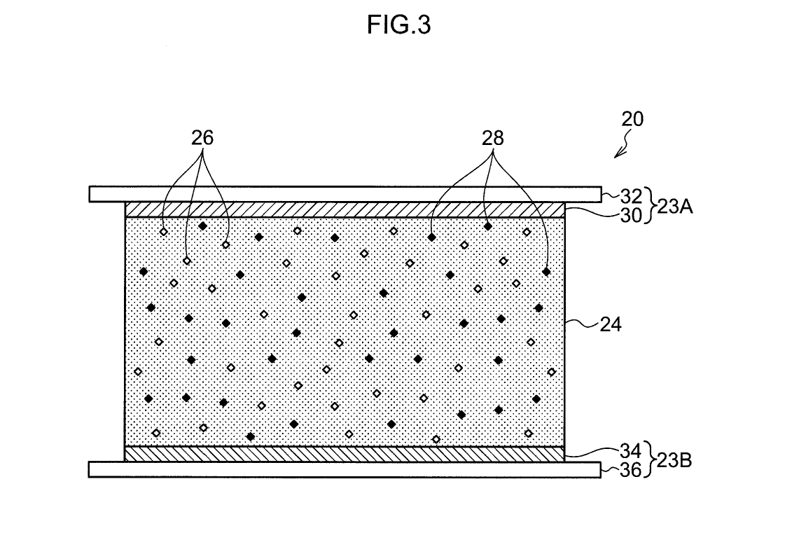

Next, the structure of the radiation detector 20 according to the first exemplary embodiment of the present invention is described. FIG. 3 is a sectional diagram showing sectional structure of the radiation detector 20 according to the first exemplary embodiment of the invention.

The radiation detector 20 according to the first exemplary embodiment of the invention has a rectangular flat plate shape, detects radiation X passing through the patient 14 as mentioned above, and images a radiation image expressed by the radiation X. In the radiation detector 20, a scintillator layer 24 is sandwiched between a first light detection board 23A and a second light detection board 23B, which are described below.

The scintillator layer 24 is constituted by two kinds of fluorescent material with mutually different sensitivities to the radiation X (K absorption edges and light emission wavelengths) being mixed together. Specifically, a first fluorescent material 26 and a second fluorescent material 28 are uniformly mixed. In order to capture a low-voltage image of soft tissues expressed by low-energy radiation of the radiation X passing through the patient 14, the radiation absorptivity μ of the first fluorescent material 26 does not have a K absorption edge, which is to say the absorptivity μ in the high-energy region does not increase discontinuously, in a high-energy region. In order to image a high-voltage image of hard tissues expressed by high-energy radiation of the radiation X passing through the patient 14, the second fluorescent material 28 has a higher radiation absorptivity μ in the high-energy region than the first fluorescent material 26.

The meaning of the term “soft tissues” as used herein includes muscles, internal organs and the like, which are tissues other than bone tissues such as cortical bones, trabecular bones and the like. The meaning of the term “hard tissues” as used herein includes hard tissues such as cortical bones, trabecular bones and the like, which are also referred to as hard structures.

Provided the first fluorescent material 26 and the second fluorescent material 28 are fluorescent materials with mutually different sensitivities to the radiation X, any commonly used fluorescent materials may be selected as appropriate and used as the scintillator. For example, two kinds may be selected from the fluorescent materials presented in the following Table 1. With a view to clearly distinguishing the low-voltage image and high-voltage image obtained by the imaging, it is preferable if the first fluorescent material 26 and the second fluorescent material 28 have mutually different sensitivities to the radiation X and also have mutually different light emission colors.

TABLE 1

| | Emitted | | K absorption |
|---|---|---|---|
| Composition | color | Wavelength (nm) | edge (eV) |
| HfP₂O₇ | Ultra-violet | 300 | 65.3 |
| YTaO₄ | Ultra-violet | 340 | 67.4 |
| BaSO₄:Eu | Violet | 375 | 37.4 |
| BaFCl:Eu | Violet | 385 | 37.4 |
| BaFBr:Eu | Violet | 390 | 37.4 |
| YTaO₄:Nb | Blue | 410 | 67.4 |
| CsI:Na | Blue | 420 | 36/33.2 |
| CaWO₄ | Blue | 425 | 69.5 |
| ZnS:Ag | Blue | 450 | 9.7 |
| LaOBr:Tm | Blue | 460 | 38.9 |
| Bi₄Ge₃O₁₂ | Blue | 480 | 90.4 |
| CdSO₄ | Blue-green | 480 | 27/69.5 |
| LaOBr:Tb | Pale blue | 380, 415, 440, 545 | 38.9 |
| Y₂O₂S:Tb | Pale blue | 380, 415, 440, 545 | 17.03 |
| Gd₂O₂S:Pr | Green | 515 | 50.2 |
| (Zn,Cd)S:Ag | Green | 530 | 9.7/27 |
| CsI:Tl | Green | 540 | 36/33.2 |
| Gd₂O₂S:Tb | Green | 545 | 60.2 |
| La₂O₂S:Tb | Green | 545 | 38.9 |

Other fluorescent materials beside those in Table 1, such as CsBr:Eu, ZnS:Cu, Gd₂O₂S:Eu, Lu₂O₂S:Tb and the like may be selected.

However, in regard to ease of formation without deliquescence, a selection is preferable in which, of the materials above, the parent material is a material other than CsI or CsBr.

In regard to not causing noise in a radiation image that is captured without a color filter that absorbs (blocks) light of predetermined wavelengths, it is preferable if the light that is emitted is light with sharp rather than broad wavelengths (a narrow light emission wavelength range), which, of the materials above, is not CsI:Tl, (Zn,Cd)S:Ag, CaWO₄:Pb, La₂OBr:Tb, ZnS:Ag or CsI:Na. As these fluorescent materials that emit light with sharp wavelengths, for example, Gd₂O₂S:Tb and La₂O₂S:Tb that emit green, and BaFX:Eu that emits blue (in which X is a halogen element such as Br or Cl) can be mentioned. Of these, in particular, a combination in which the first fluorescent material 26 and the second fluorescent material 28 are Gd₂O₂S:Tb emitting green and BaFX:Eu emitting blue is preferable.

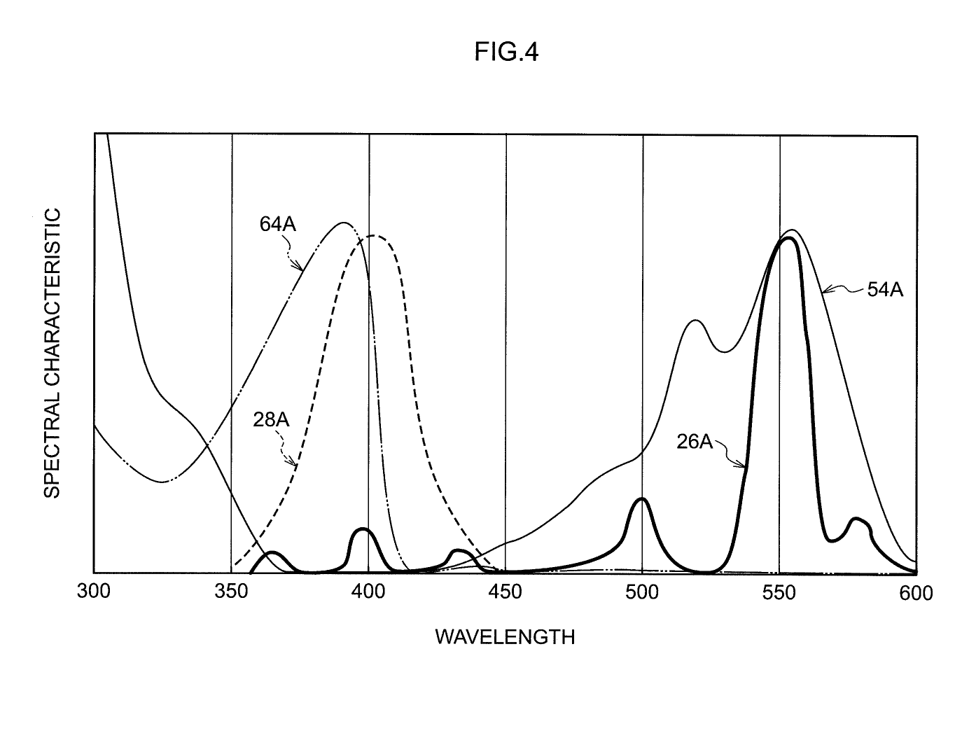

For the first fluorescent material 26 and the second fluorescent material 28, fluorescent materials with mutually different sensitivities to the radiation X are selected, and peak light emission wavelength of the lights are mutually different. Thus, as shown in FIG. 4, the first fluorescent material 26 primarily responds to low-energy radiation in the irradiated radiation X and converts the radiation to light 26A of which a peak is a first wavelength. The second fluorescent material 28 primarily responds to radiation of higher energies than the low energies in the radiation X, and converts the radiation X to light 28A of which a peak is a second wavelength that is different from the first wavelength.

In FIG. 4, an example of spectral characteristics of the fluorescent materials 26 and 28 is shown for a case in which the first fluorescent material 26 is Gd₂O₂S:Tb that emits green and the second fluorescent material 28 is BaFXBr:Eu that emits blue. Provided the spectral characteristics of the first fluorescent material 26 and the second fluorescent material 28 conform to the above description, spectral characteristics with other shapes may be used. In FIG. 4, the first wavelength is longer than the second wavelength, but the first wavelength may be shorter than the second wavelength. The horizontal axis in FIG. 4 represents wavelengths of light and the vertical axis represents a spectral characteristic, that is, relative light emission intensities of the lights.

Returning to FIG. 3, the light emitted by the scintillator layer 24 is received by the first light detection board 23A and the second light detection board 23B. The first light detection board 23A is provided with a first photoelectric conversion layer 30 and a TFT active matrix substrate 32 (hereinafter referred to as a TFT board). Similarly, the second light detection board 23B is provided with a second photoelectric conversion layer 34 and a TFT board 36.

The first photoelectric conversion layer 30 is disposed between the scintillator layer 24 and the TFT board 32, receives light emitted by the scintillator layer 24, and converts the light to charges. The second photoelectric conversion layer 34 is disposed between the scintillator layer 24 and the TFT board 36, receives light emitted by the scintillator layer 24, and converts the light to charges. The first photoelectric conversion layer 30 and the second photoelectric conversion layer 34 are provided with photoelectric conversion films, which are described below, constituted by organic materials with mutually different light absorption characteristics.

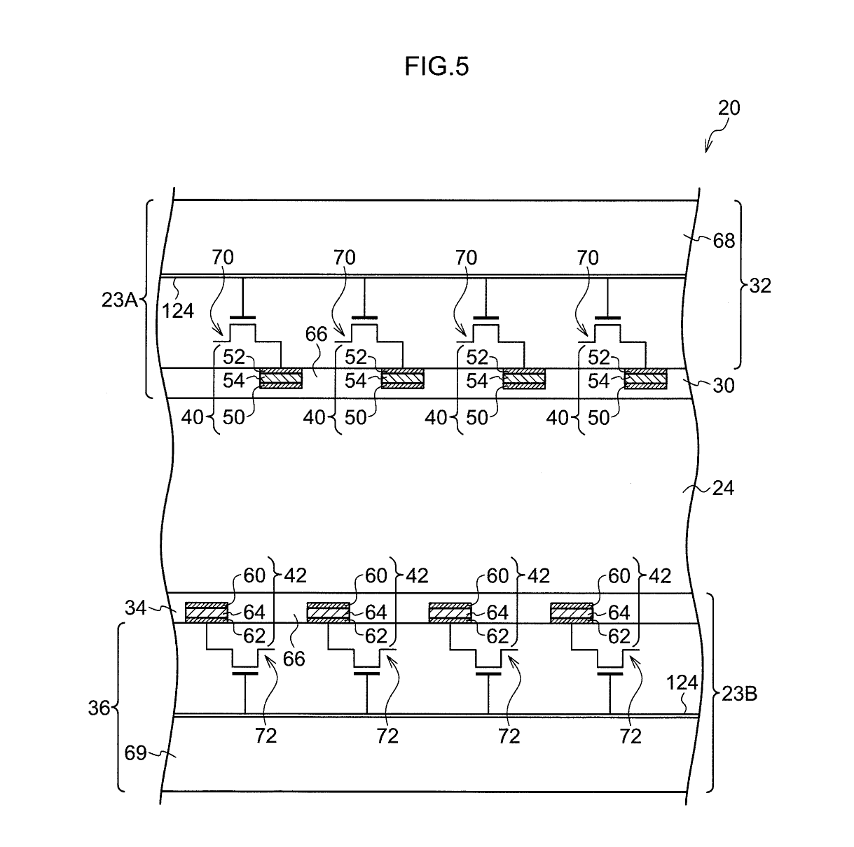

FIG. 5 is a sectional diagram showing detailed structure of the radiation detector 20 shown in FIG. 3.

As shown in FIG. 5, a plural number of first light detection sensors 40 are formed at the first photoelectric conversion layer 30, and a plural number of second light detection sensors 42 are formed at the second photoelectric conversion layer 34. The second light detection sensors 42 have the same total light receiving area as a total light receiving area of the first light detection sensors 40. The respective first light detection sensors 40 and second light detection sensors 42 constitute individual pixels of radiation images expressed by the radiation X that has passed through the patient 14.

Each first light detection sensor 40 includes a first electrode 50, a second electrode 52, and a first organic photoelectric conversion film 54 disposed between the electrodes above and below. Each second light detection sensor 42 includes a first electrode 60, a second electrode 62, and a second organic photoelectric conversion film 64 disposed between the electrodes above and below. The second organic photoelectric conversion film 64 has a different light absorption characteristic from the first organic photoelectric conversion film 54.

The first organic photoelectric conversion film 54 absorbs more of the first wavelength light 26A emitted from the first fluorescent material 26 of the scintillator layer 24 than of the second wavelength light 28A, and converts the absorbed light to corresponding charges, that is, generates charges. The light absorption characteristic of this first organic photoelectric conversion film 54 is, for example, the characteristic 54A shown in FIG. 4. According to this constitution, because the second wavelength light 28A is not absorbed as much as the first wavelength light 26A, noise produced by the second wavelength light 28A being absorbed by the first organic photoelectric conversion films 54 may be effectively suppressed.

The second organic photoelectric conversion film 64 absorbs more of the second wavelength light 28A emitted from the second fluorescent material 28 of the scintillator layer 24 than of the first wavelength light 26A, and converts the absorbed light to corresponding charges, that is, generates charges. The light absorption characteristic of this second organic photoelectric conversion film 64 is, for example, the characteristic 64A shown in FIG. 4. According to this constitution, because the first wavelength light 26A is not absorbed as much as the second wavelength light 28A, noise produced by the first wavelength light 26A being absorbed by the second organic photoelectric conversion films 64 may be effectively suppressed.

In regard to further suppressing this noise, it is preferable if the first organic photoelectric conversion films 54 transmit at least 95% of the second wavelength light 28A and selectively absorb the first wavelength light 26A and the second organic photoelectric conversion films 64 transmit at least 95% of the first wavelength light 26A and selectively absorb the second wavelength light 28A. It is more preferable if the first organic photoelectric conversion films 54 completely transmit the second wavelength light 28A and selectively absorb the first wavelength light 26A, while the second organic photoelectric conversion films 64 completely transmit the first wavelength light 26A and selectively absorb the second wavelength light 28A.

In FIG. 4, an example of spectral characteristics of the organic photoelectric conversion films 54 and 64 is shown for a case in which each first organic photoelectric conversion film 54 is constituted of a green-absorbing quinacridone and each second organic photoelectric conversion film 64 is constituted of a blue-absorbing combination of a p-type material containing a rubrene and an n-type material containing a fullerene or a higher fullerene. However, the spectral characteristics of the first organic photoelectric conversion films 54 and second organic photoelectric conversion films 64 may be spectral characteristics with some other form provided they comply with the description above. The horizontal axis in FIG. 4 represents wavelengths of light and the vertical axis represents a spectral characteristic, that is, a light absorption characteristic.

The functionality described above may be realized by the first organic photoelectric conversion films 54 and second organic photoelectric conversion films 64 being constituted with materials suitably selected from organic materials so as to have mutually different light absorption characteristics.

As well as the above-mentioned quinacridone and combination of a p-type material containing rubrene and an n-type material containing fullerene or a higher fullerene, examples of the materials of the first organic photoelectric conversion films 54 and second organic photoelectric conversion films 64 include red-absorbing phthalocyanines, blue-absorbing anthraquinones, and so forth.

As a method for forming the first organic photoelectric conversion films 54 and second organic photoelectric conversion films 64, because the first organic photoelectric conversion films 54 and second organic photoelectric conversion films 64 are constituted by organic materials as mentioned above, an inkjet system may be used instead of the commonly used vapor deposition technique. When an inkjet system is used, thicknesses of the first organic photoelectric conversion films 54 and the second organic photoelectric conversion films 64 may be regulated by over-printing of liquids containing the organic materials.

Gaps are formed between adjacent first organic photoelectric conversion films 54 and between adjacent second organic photoelectric conversion films 64 such that the generated charges do not pass therebetween. These gaps are filled with a planarizing film 66 so as to flatten the TFT boards 32 and 36.

The charges generated by the first organic photoelectric conversion films 54 are read out by the TFT board 32. At the TFT board 32, a plural number of TFT switches 70 are formed under a support substrate 68. The TFT switches 70 convert charges that have migrated from the first organic photoelectric conversion films 54 to the second electrodes 52 to electronic signals and output the electronic signals.

The charges generated by the second organic photoelectric conversion films 64 are read out by the TFT board 36. At the TFT board 36, a plural number of TFT switches 72 are formed over a support substrate 69. The TFT switches 72 convert charges that have migrated from the second organic photoelectric conversion films 64 to the second electrodes 62 to electronic signals and output the electronic signals.

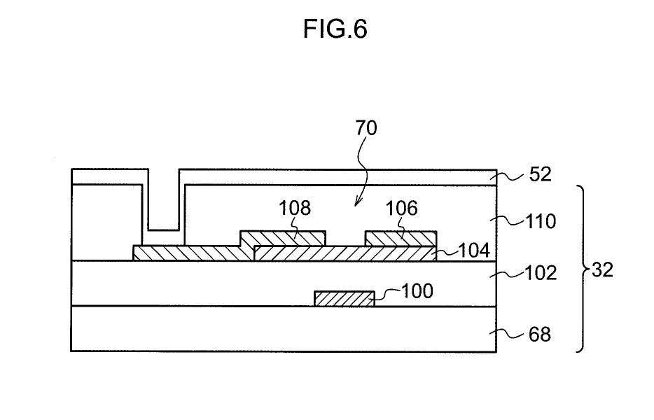

FIG. 6 is a diagram schematically showing the structure of each TFT switch 70. Each TFT switch 72 has the same structure as the TFT switch 70, so is not described here.

A region in which the TFT switch 70 is formed includes a portion that overlaps with the second electrode 52 in plan view. With this structure, the TFT switch 70 and first light detection sensor 40 of each pixel region are superposed in the thickness direction. In order to minimize the area of (pixel regions of) the radiation detector 20, it is desirable if regions in which the TFT switches 70 are formed are completely covered over by the second electrodes 52.

In each TFT switch 70, a gate electrode 100, a gate insulation film 102 and an active layer (channel layer) 104 are layered, and a source electrode 106 and a drain electrode 108 are disposed above the active layer 104, a predetermined spacing apart therefrom. An insulating film 110 is provided between the TFT switch 70 and the second electrode 52.

It is preferable if the active layer 104 of the TFT switch 70 is formed of a non-crystalline oxide. The non-crystalline oxide is preferably an oxide including at least one of indium, gallium and zinc (for example, In—O), is more preferably an oxide including at least two of indium, gallium and zinc (for example, In—Zn—O, In—Ga—O or Ga—Zn—O), and is particularly preferably an oxide including indium, gallium and zinc. An In—Ga—Zn—O non-crystalline oxide is preferably a non-crystalline oxide whose composition in a crystalline state is represented by InGaO₃(ZnO)ₘ (m being a natural number of less than 6), and is particularly preferably InGaZnO₄.

If the active layer 104 of the TFT switch 70 is formed of a non-crystalline oxide, it does not absorb radiation such as X-rays or the like, or even if it does absorb such radiation, the radiation is only stopped in tiny amounts. Therefore, the production of noise may be effectively suppressed.

The non-crystalline oxide, and the organic materials constituting the first organic photoelectric conversion films 54 (and the second organic photoelectric conversion films 64) may each be formed at a low temperature. Therefore, if the active layer 104 is constituted by a non-crystalline oxide, the support substrate 68 is not limited to substrates with high thermal resistance such as semiconductor substrates, quartz substrates, glass substrates and the like, and flexible substrates of plastic or the like, or aramids or bionanofibers may be used. Specifically, a flexible substrate of a polyester such as polyethylene terephthalate, polybutylene phthalate, polyethylene naphthalate or the like, or a polystyrene, polycarbonate, polyether sulfone, polyarylate, polyimide, polycycloolefin, norbornene resin, poly(chlorotrifluoro ethylene) or the like may be used. If a flexible substrate made of such a plastic is used, weight may be reduced, which is advantageous to, for example, portability and the like. On the support substrate 68, the following layers may be provided: an insulating layer for ensuring insulation; a gas barrier layer for preventing the permeation of moisture, oxygen and the like; an undercoating layer for improving flatness and contact with the electrodes and the like; and so forth.

With aramid, high temperature processes at up to over 200° C. may be applied. Therefore, a transparent electrode material may be cured at high temperature and resistance may be lowered. Moreover, automatic mounting to a driver chip, including a solder reflow step, may be applied. Aramid has a thermal expansion coefficient close to that of ITO (indium tin oxide) or a glass substrate or the like. Therefore, there is little curling after fabrication and breakage is unlikely. Aramid may form a thinner substrate than a glass substrate or the like. An ultra-thin glass substrate and aramid may be laminated to form the support substrate 68.

A bionanofiber is a combination of cellulose microfibril bundles (microbial cellulose) produced by bacteria (Acetobacter Xylinum) and a transparent resin. The cellulose microfibril bundles have widths of 50 nm, a size that is a tenth of a visible light wavelength, and have high strength, high resilience and low thermal expansion. The microbial cellulose is immersed in a transparent resin such as an acrylic resin, an epoxy resin or the like, and the resin is hardened. Thus, bionanofibers are provided that contain 60-70% fibers and exhibit a transparency of about 90% for a wavelength of 500 nm. The bionanofiber has a low thermal expansion coefficient (3-7 ppm) compared with silicon crystal, has a strength comparable with steel (460 MPa) and a high resilience (30 GPa), and is flexible. Therefore, a thinner support substrate 68 may be formed than from a glass substrate or the like.

While the support substrate 68 of the TFT switches 70 has been described, the same materials may be selected for the support substrate 69 of the TFT switches 72.

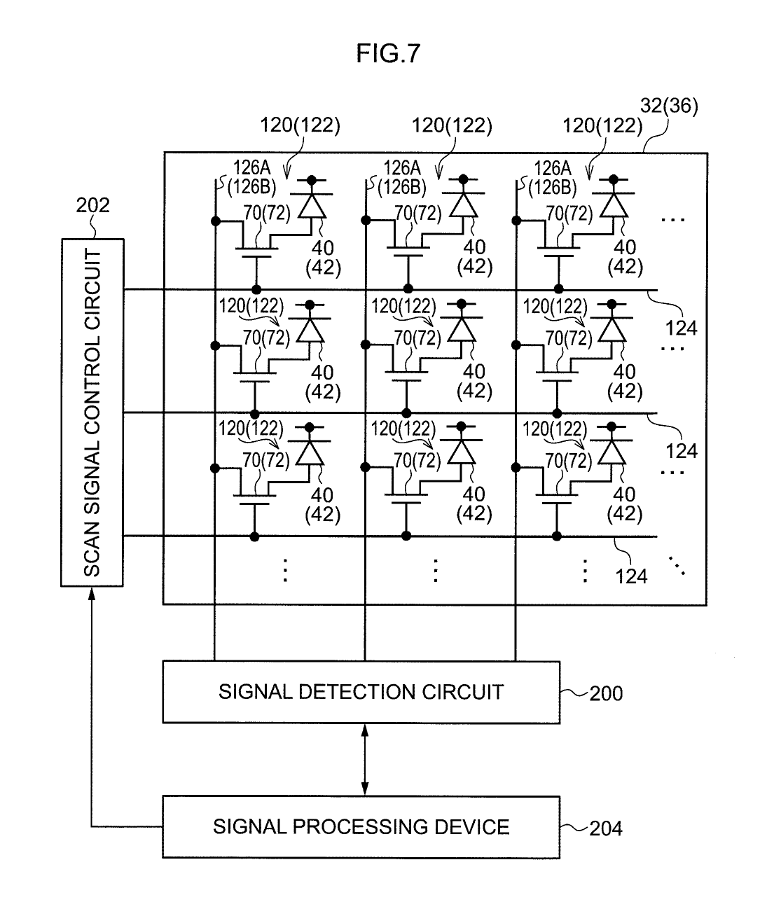

FIG. 7 is a diagram showing a wiring structure of the TFT board 32. The wiring structure of the TFT board 36 is the same as the wiring structure of the TFT board 32, and is denoted in the same drawing.

As shown in FIG. 7, in the TFT board 32, a plural number of pixels 120 that each include the above-described first light detection sensor 40 and TFT switch 70 are two-dimensionally arranged in a certain direction (the row direction in FIG. 7) and a direction orthogonal to the certain direction (the column direction in FIG. 7).

Similarly, in the TFT board 36, a plural number of pixels 122 that each include the above-described second light detection sensor 42 and TFT switch 72 are two-dimensionally arranged in the certain direction (the row direction in FIG. 7) and the direction orthogonal to the certain direction (the column direction in FIG. 7).

In the TFT board 32, scan lines 124 are provided in parallel in the certain direction for the respective pixel rows, and signal lines 126 are provided in parallel in the orthogonal direction for the respective pixel columns. The signal lines 126 are constituted by pairs of signal lines, first signal lines 126A corresponding with the pixels 120 and second signal lines 126B corresponding with the pixels 122.

At each TFT switch 70, the source is connected to the first light detection sensor 40, the drain is connected to the first signal line 126A, and the gate is connected to the scan line 124. At each TFT switch 72, the source is connected to the second light detection sensor 42, the drain is connected to the second signal line 126B, and the gate is connected to the scan line 124.

When a TFT switch 70 connected to a first signal line 126A is turned on, electronic signals corresponding to charges generated and accumulated at the first light detection sensor 40 flow into the first signal line 126A. When a TFT switch 72 connected to a second signal line 126B is turned on, electronic signals corresponding to charges generated and accumulated at the second light detection sensor 42 flow into the second signal line 126B.

A signal detection circuit 200 that detects the electronic signals flowing into these lines is connected to the first signal lines 126A and the second signal lines 126B. A scan signal control circuit 202 is connected to the scan lines 124. The scan signal control circuit 202 outputs control signals that turn the TFT switches 70 and 72 on and off to the scan lines 124. The signal detection circuit 200 and scan signal control circuit 202 are provided at the control board 22 (see FIG. 2).

The signal detection circuit 200 incorporates an amplification circuit for each of the first signal lines 126A and each of the second signal lines 126B. The amplification circuits amplify the inputted electronic signals. By amplifying the electronic signals inputted from the first signal lines 126A and second signal lines 126B and detecting the amplified electronic signals, the signal detection circuit 200 detects charge amounts generated at the first light detection sensors 40 of the pixels 120 to serve as information of pixels constituting a low-voltage image and detects charge amounts generated at the second light detection sensors 42 of the pixels 122 to serve as information of pixels constituting a high-voltage image.

A signal processing device 204 is connected to the signal detection circuit 200 and the scan signal control circuit 202. The signal processing device 204 divides the pixel information detected by the signal detection circuit 200 into pixel information from the first signal lines 126A and pixel information from the second signal lines 126B and applies predetermined processing thereto. The signal processing device 204 also outputs control signals representing signal detection timings to the signal detection circuit 200 and outputs control signals representing scan signal output timings to the scan signal control circuit 202.

The signal processing device 204 is provided at the control board 22 (see FIG. 2). As the predetermined processing, in cases where required, the signal processing device 204 carries out processing to obtain an energy subtraction image by applying subtraction image processing using the low-voltage image and high-voltage image that are obtained.

Operation

Next, operation of the radiation detector 20 according to the first exemplary embodiment of the present invention is described.

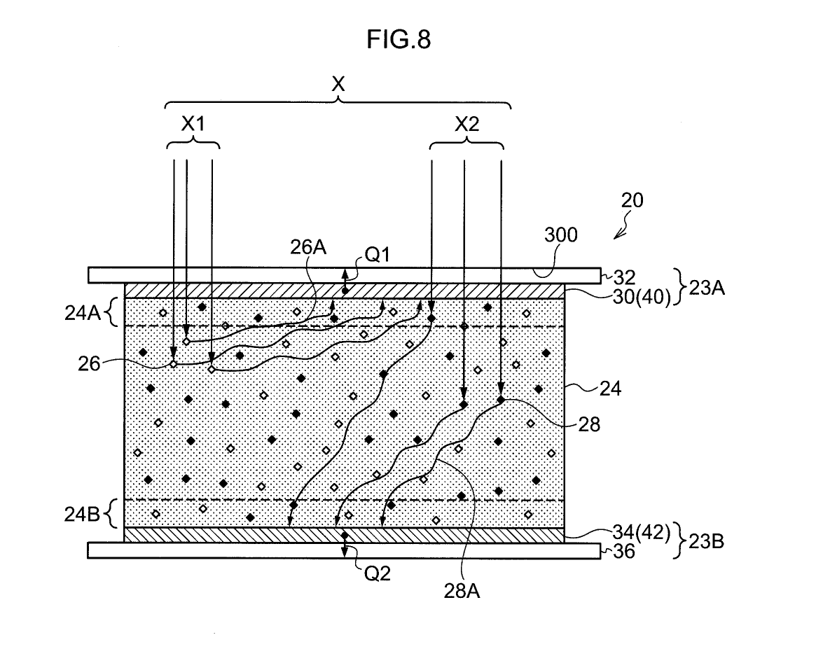

FIG. 8 is a diagram describing operation of the radiation detector 20 in accordance with the first exemplary embodiment of the present invention.

In a case of capturing a radiation image, radiation X passing through the patient 14 is irradiated at the radiation detector 20. The radiation X passing through the patient 14 includes a low-energy component and a high-energy component. Hereinafter, radiation of the low-energy component of the radiation X is referred to as low-energy radiation X1, and radiation of the high-energy component of the radiation X is referred to as high-energy radiation X2.

The radiation detector 20 according to the first exemplary embodiment of the invention is embedded in the electronic cassette 10 such that an upper face (outer face) of the TFT board 32 of the radiation detector 20 is a radiation X irradiated surface 300. In the radiation detector 20, the first photoelectric conversion layer 30, the scintillator layer 24, the second photoelectric conversion layer 34 and the TFT board 36 are layered in this order from the side at which the TFT board 32 is disposed. Therefore, the irradiated radiation X is incident on the scintillator layer 24 after passing through the TFT board 32 and the first photoelectric conversion layer 30.

When the radiation X is incident on the scintillator layer 24, the first fluorescent material 26 of the scintillator layer 24 primarily responds to the low-energy radiation X1 in the irradiated radiation X and converts the radiation X to the light 26A whose peak is the first wavelength. Meanwhile, the second fluorescent material 28 of the scintillator layer 24 primarily responds to the high-energy radiation X2 more than to low energies in the irradiated radiation X and converts the radiation X to the light 28A whose peak is the second wavelength. Hence, the first wavelength light 26A and second wavelength light 28A emitted from the scintillator layer 24 are incident on the first photoelectric conversion layer 30 and the second photoelectric conversion layer 34.

When the first wavelength light 26A and the second wavelength light 28A are incident on the first photoelectric conversion layer 30, the first light detection sensors 40 of the first photoelectric conversion layer 30 absorb the first wavelength light 26A in larger amounts than the second wavelength light 28A and convert the absorbed light to charges Q1. Meanwhile, when the first wavelength light 26A and the second wavelength light 28A are incident on the second photoelectric conversion layer 34, the second light detection sensors 42 of the second photoelectric conversion layer 34 absorb the second wavelength light 28A in larger amounts than the first wavelength light 26A and convert the absorbed light to charges Q2.

Subsequently, as shown in FIG. 7, “on” signals are sequentially applied to the gates of the TFT switches 70 and 72 via the scan lines 124. As a result, the TFT switches 70 and 72 are sequentially turned on, the charges Q1 generated at the first light detection sensors 40 flow into the first signal lines 126A as electronic signals, and the charges Q2 generated at the second light detection sensors 42 flow into the second signal lines 126B as electronic signals.

The signal detection circuit 200 detects the charge amounts generated at the first light detection sensors 40 and the second light detection sensors 42 on the basis of the electronic signals flowing into the first signal lines 126A and the second signal lines 126B, to serve as information of the pixels 120 and 122 constituting the images. The signal processing device 204 divides the information of the pixels 120 and 122 detected by the signal detection circuit 200 into image information from the first signal lines 126A and image information from the second signal lines 126B and applies the predetermined processing thereto. Thus, image information representing a radiation image expressed by the low-energy radiation X1 irradiated at the radiation detector 20 (a low-voltage image) and image information representing a radiation image expressed by the high-energy radiation X2 (a high-voltage image) may be simultaneously obtained.

Thus, two radiation images, the low-voltage image and the high-voltage image, may be obtained by a single irradiation of the radiation X.

Because the first photoelectric conversion layer 30 as described above is disposed closer to the side from which the radiation X is irradiated than the scintillator layer 24 containing the first fluorescent material 26, the radiation X is irradiated onto a scintillator region at the side of the scintillator layer 24 at which the first photoelectric conversion layer 30 is disposed (for example, region 24A in FIG. 8). Thus, the scintillator region 24A at the first photoelectric conversion layer 30 side primarily absorbs the radiation X and emits light. Because the scintillator region 24A that primarily absorbs the radiation X and emits light is at the first photoelectric conversion layer 30 side of the scintillator layer 24, a distance between the scintillator region 24A and the first photoelectric conversion layer 30 is shorter than in a reverse arrangement of the first photoelectric conversion layer 30 and the scintillator layer 24 by an amount corresponding to the thickness of the scintillator layer 24.

As a result, received light amounts of the first wavelength light 26A emitted from the first fluorescent material 26 primarily responding to the low-energy radiation X1 that are received at the first photoelectric conversion layer 30 are increased, and a high image quality low-voltage image of the patient 14 expressed by the low-energy radiation X1 is obtained.

Because soft tissues are generally more finely structured than hard tissues, high image quality is more useful in low-voltage images than in high-voltage images in the respect that finely structured regions of soft tissues may be reliably viewed.

Because the first photoelectric conversion layer 30 is constituted by an organic material, an absorption proportion of the radiation X is generally very low compared to a case in which a photoelectric conversion layer is constituted by an inorganic material such as non-crystalline silicon or the like. Therefore, even though the first photoelectric conversion layer 30 is disposed at the side from which the radiation X is irradiated relative to the scintillator layer 24, a large proportion of the radiation X is incident on the scintillator layer 24. Thus, a reduction in light emission amounts from the scintillator layer 24 may be suppressed, and hence a deterioration of image quality may be suppressed.

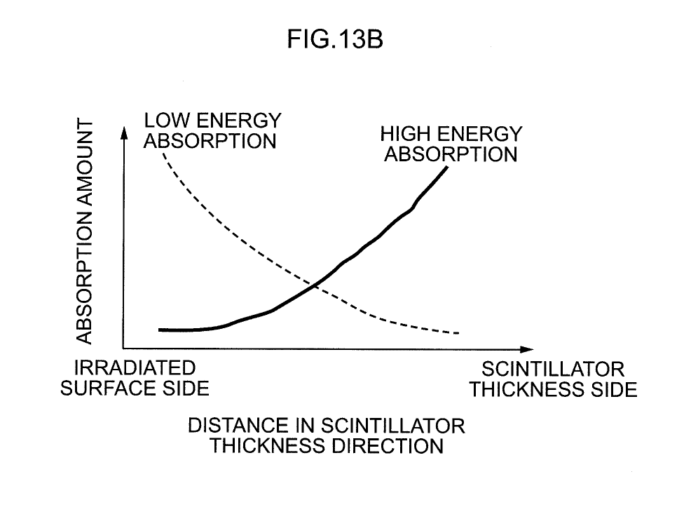

Now, the scintillator layer 24 is a single layer in which the first fluorescent material 26 and the second fluorescent material 28 are mixed, and the low-energy radiation X1 of the radiation X incident on the scintillator layer 24 generally tends to be absorbed more at the scintillator region 24A at the radiation X irradiated surface 300 side of the scintillator layer 24 (see FIG. 13B). Meanwhile, the high-energy radiation X2 with greater energies than the low energies in the radiation X incident on the scintillator layer 24 generally tends to be absorbed more at a scintillator region (for example, region 24B) at the opposite side of the scintillator layer 24 from the side at which the radiation X irradiated surface 300 is disposed (see FIG. 13B).

Therefore, the low-energy radiation X1 is incident in smaller amounts than the high-energy radiation X2 at the scintillator region at the opposite side from the radiation X irradiated surface 300 side. Therefore, in the scintillator region at the opposite side from the radiation X irradiated surface 300 side, light emission amounts of the second wavelength light 28A from the second fluorescent material 28 are greater than light emission amounts of the first wavelength light 26A from the first fluorescent material 26. Thus, the second photoelectric conversion layer 34 that is layered next after the scintillator layer 24 as seen from the radiation X irradiated surface 300 side receives the second wavelength light 28A in larger amounts than the first wavelength light 26A, and a high-voltage image with little noise may be obtained.

### Second Exemplary Embodiment

Next, the structure of a radiation detector according to a second exemplary embodiment of the present invention is described.

Structure of the Radiation Detector

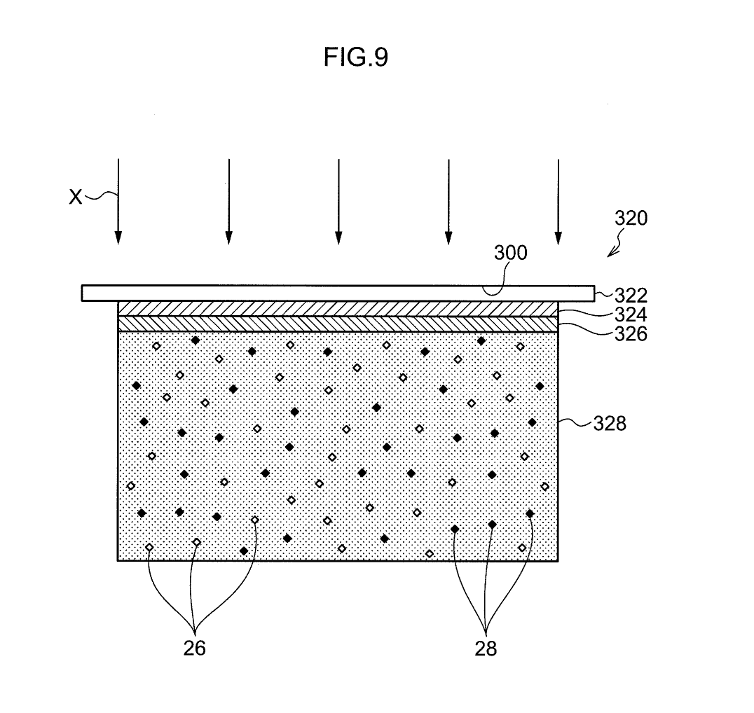

FIG. 9 is a sectional diagram showing the sectional structure of a radiation detector 320 according to the second exemplary embodiment of the invention.

As shown in FIG. 9, the structure of the radiation detector 320 according to the second exemplary embodiment of the invention is similar to the structure shown in FIG. 3 described in the first exemplary embodiment but, unlike the first exemplary embodiment, there is only one TFT board. The sequence of layering of the respective structures is also different.

Specifically, in the radiation detector 320 according to the second exemplary embodiment of the invention, a TFT board 322 is provided with structure the same as the structure of the TFT board 32 and is provided with structure the same as the structure of the TFT board 36. In other words, the TFT board 322 is provided with a constitution that reads out both charges generated from a first photoelectric conversion layer 324 and charges generated from a second photoelectric conversion layer 326. The first photoelectric conversion layer 324, the second photoelectric conversion layer 326 and a scintillator layer 328 have a different arrangement but are equipped with the same structures as the first photoelectric conversion layer 30, the second photoelectric conversion layer 34 and the scintillator layer 24.

The first photoelectric conversion layer 324, second photoelectric conversion layer 326 and scintillator layer 328 are layered in this order from the TFT board 322, which serves as the radiation X irradiated surface 300.

Operation

According to the above constitution of the radiation detector 320 according to the second exemplary embodiment of the invention, the irradiated radiation X is incident on the TFT board 322, the first photoelectric conversion layer 324, the second photoelectric conversion layer 326 and the scintillator layer 328 in this order. When the radiation X is incident on the scintillator layer 328, a scintillator region at the radiation X irradiated surface 300 side of the scintillator layer 328 primarily emits light. Therefore, the first photoelectric conversion layer 324 may receive the first wavelength light 26A in larger amounts corresponding to the amount by which the distance between the scintillator region at the radiation X irradiated surface 300 side and the first photoelectric conversion layer 324 is shorter. Hence, a high image quality low-voltage image may be obtained.

In this constitution, the radiation X is incident on the first photoelectric conversion layer 324 and the second photoelectric conversion layer 326 before the scintillator layer 328. However, because the first photoelectric conversion layer 324 and the second photoelectric conversion layer 326 are both constituted with organic materials, radiation absorption proportions are generally very low compared to cases of constitution with inorganic materials. Therefore, even though the first photoelectric conversion layer 324 and the second photoelectric conversion layer 326 are layered at the radiation X irradiated surface 300 side relative to the scintillator layer 328, a large proportion of the radiation X is incident on the scintillator layer 328. Thus, a reduction in light emission amounts from the scintillator layer 328 may be suppressed, and hence a deterioration in image quality may be suppressed.

Because the first photoelectric conversion layer 324 and the second photoelectric conversion layer 326 adjoin one another and are not distantly separated, there is no need for roundabout wiring or the like, and charges may be read out from the first photoelectric conversion layer 324 and the second photoelectric conversion layer 326 at the single TFT board 322.

### Third Exemplary Embodiment

Next, a radiation detector according to a third exemplary embodiment of the present invention is described.

Structure of the Radiation Detector

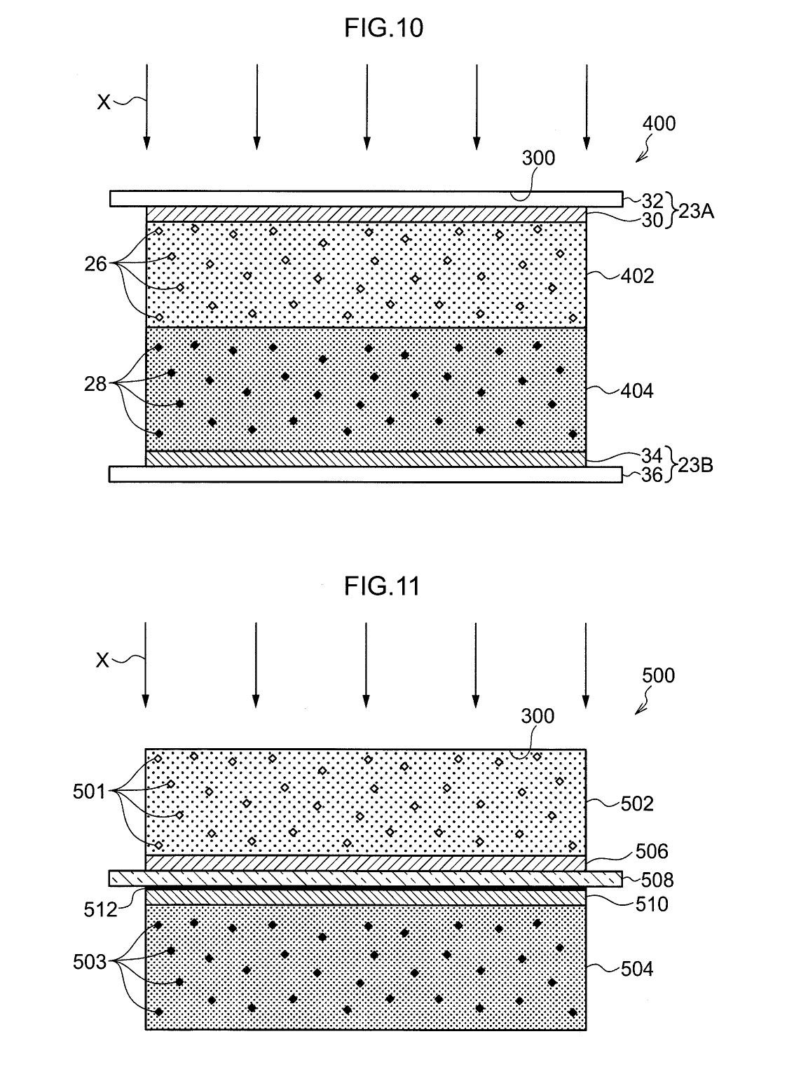

FIG. 10 is a sectional diagram showing the sectional structure of a radiation detector 400 according to the third exemplary embodiment of the invention.

As shown in FIG. 10, the structure of the radiation detector 400 according to the third exemplary embodiment of the invention is similar to the structure shown in FIG. 3 described in the first exemplary embodiment but, unlike the first exemplary embodiment, the first fluorescent material and second fluorescent material of the scintillator layer are not mixed but formed as separate layers.

Specifically, the radiation detector 400 according to the third exemplary embodiment of the invention is provided with one scintillator layer 402 that is constituted with the first fluorescent material 26 and another scintillator layer 404 that is constituted with the second fluorescent material 28. From the TFT board 32 that serves as the radiation X irradiated surface 300, the first photoelectric conversion layer 30, the one scintillator layer 402, the other scintillator layer 404, the second photoelectric conversion layer 34 and the TFT board 36 are layered in this order.

Operation

According to the above constitution of the radiation detector 400 according to the third exemplary embodiment of the invention, when the radiation X is incident, the one scintillator layer 402 emits the first wavelength light 26A and the other scintillator layer 404 emits the second wavelength light 28A.

Thus, the first photoelectric conversion layer 30 receives more of the first wavelength light 26A than of the second wavelength light 28A by amounts corresponding to the amount by which the distance from the one scintillator layer 402 at the first photoelectric conversion layer 30 side that emits the first wavelength light 26A is shorter than the distance from the other scintillator layer 404 at the second photoelectric conversion layer 34 side that emits the second wavelength light 28A. Thus, a low-voltage image with little noise may be obtained.

Meanwhile, the second photoelectric conversion layer 34 receives more of the second wavelength light 28A than of the first wavelength light 26A by amounts corresponding to the amount by which the distance from the other scintillator layer 404 at the second photoelectric conversion layer 34 side that emits the second wavelength light 28A is shorter than the distance from the one scintillator layer 402 at the first photoelectric conversion layer 30 side that emits the first wavelength light 26A. Thus, a high-voltage image with little noise may be obtained.

### Fourth Exemplary Embodiment

Next, a radiation detector according to a fourth exemplary embodiment of the present invention is described.

Structure of the Radiation Detector

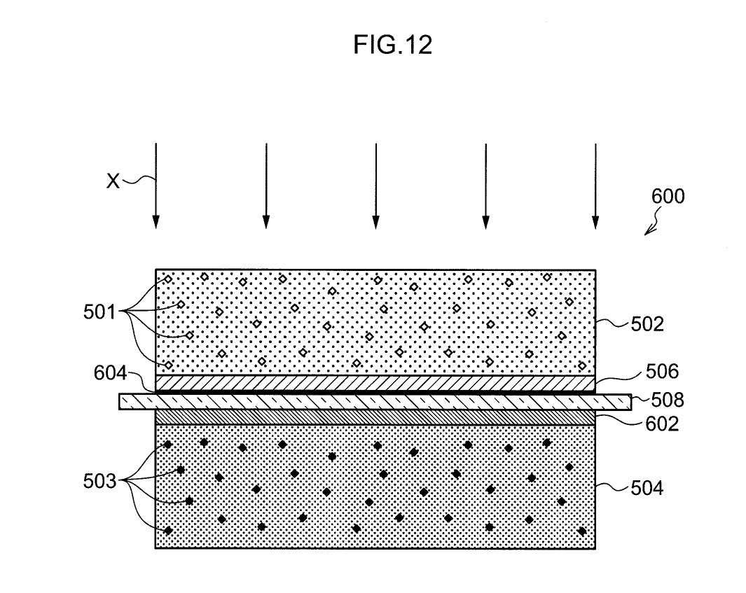

FIG. 11 is a sectional diagram showing the sectional structure of a radiation detector 500 according to the fourth exemplary embodiment of the invention.

As shown in FIG. 11, the structure of the radiation detector 500 according to the fourth exemplary embodiment of the invention is similar to the structure shown in FIG. 3 described in the first exemplary embodiment but, unlike the first exemplary embodiment, there is only one TFT board. The sequence of layering of the respective structures is also different. Moreover, the first fluorescent material and second fluorescent material of the scintillator layer are not mixed but formed as separate layers.

Specifically, the radiation detector 500 according to the fourth exemplary embodiment of the invention is provided with one scintillator layer 502 that is constituted with a second fluorescent material 501 and another scintillator layer 504 that is constituted with a first fluorescent material 503.

In the present exemplary embodiment, the radiation absorption characteristics of the first fluorescent material 503 and the second fluorescent material 501 are the reverse of those in the first exemplary embodiment. The first fluorescent material 503 primarily responds to the high-energy radiation X2 rather than low energies of the irradiated radiation X and converts the radiation X to the light whose peak is the first wavelength 26A, and the second fluorescent material 501 primarily responds to the low-energy radiation X1 rather than high energies of the irradiated radiation X and converts the radiation X to the light whose peak is the second wavelength 28A.

A TFT board 508 is provided with structure the same as the structure of the TFT board 32 and is provided with structure the same as the structure of the TFT board 36. In other words, the TFT board 508 is provided with a constitution that reads out both charges generated from a first photoelectric conversion layer 510 and charges generated from a second photoelectric conversion layer 506.

The second photoelectric conversion layer 506, the TFT board 508, the first photoelectric conversion layer 510 and the other scintillator layer 504 are layered in this order from the one scintillator layer 502.

If required, a color filter 512 is provided as appropriate between the first photoelectric conversion layer 510 and the TFT board 508 or between the second photoelectric conversion layer 506 and the TFT board 508. The color filter 512 absorbs light from the one scintillator layer 502 or the other scintillator layer 504. The color filter 512 need not absorb all the light from the one scintillator layer 502 or other scintillator layer 504. For example, in a case in which excess second wavelength light 28A is emitted from the other scintillator layer 504 as well as the first wavelength light 26A, it is sufficient that this excess second wavelength light 28A is not absorbed by the second photoelectric conversion layer 506 that is at the irradiated surface 300 side relative to the color filter 512.

Specifically, in a case in which the first photoelectric conversion layer 510 has a green absorption characteristic and the second photoelectric conversion layer 506 has a blue absorption characteristic, the color filter 512 may have a blue absorption characteristic and be disposed such that the second photoelectric conversion layer 506 does not absorb blue light from the other scintillator layer 504. For example, if the first fluorescent material 503 of the other scintillator layer 504 is green-emitting GOS:Tb (which includes a little blue emission) and the second fluorescent material 501 of the one scintillator layer 502 is blue-emitting BaFBr:Eu, the blue-absorbing color filter 512 may be disposed such that the second photoelectric conversion layer 506 does not absorb the slight blue emissions from the first fluorescent material 503.

Operation

According to the above constitution of the radiation detector 500 according to the fourth exemplary embodiment of the invention, a low-voltage image expressed by the low-energy radiation X1 can be obtained by the second photoelectric conversion layer 506 absorbing more of the second wavelength light 28A from the one scintillator layer 502 than of the first wavelength light 26A from the other scintillator layer 504 and converting the light to charges. Meanwhile, a high-voltage image expressed by the high-energy radiation X2 can be obtained by the first photoelectric conversion layer 510 absorbing more of the first wavelength light 26A from the other scintillator layer 504 than of the second wavelength light 28A from the one scintillator layer 502 and converting the light to charges.

Because the first photoelectric conversion layer 510 is disposed at the radiation X irradiated surface 300 side relative to the other scintillator layer 504 constituted with the first fluorescent material 503, a distance between the scintillator region of the other scintillator layer 504 that primarily emits light and the first photoelectric conversion layer 510 is short, and hence a high image quality high-voltage image of the patient 14 expressed by the high-energy radiation X2 may be obtained.

Generally, a scintillator layer emits light in light emission amounts that are larger for radiation that is directly incident than for radiation passing through a photoelectric conversion layer and a TFT board or the like by amounts corresponding to the absence of the possibility of the radiation X being absorbed. If, for example, the thickness of the one scintillator layer 502 is increased, the distance between a scintillator region in the one scintillator layer 502 that primarily emits light and the second photoelectric conversion layer 506 becomes further. However, according to the structure of the radiation detector 500 according to the fourth exemplary embodiment of the invention, the thickness of the one scintillator layer 502 at the second photoelectric conversion layer 506 side may be reduced by an amount corresponding to the provision of the other scintillator layer 504 at the first photoelectric conversion layer 510 side, which is at a non-irradiated face side relative to the second photoelectric conversion layer 506. Then, if the thickness of the one scintillator layer 502 is reduced, the distance between the scintillator region of the one scintillator layer 502 that primarily absorbs the radiation X and emits light and the second photoelectric conversion layer 506 is reduced, and received light amounts of the second wavelength light 26A received by the second photoelectric conversion layer 506 increase. Hence, a high image quality low-voltage image of the patient 14 expressed by the low-energy radiation X1 may be obtained.

### Fifth Exemplary Embodiment

Next, a radiation detector according to a fifth exemplary embodiment of the present invention is described.

Structure of the Radiation Detector

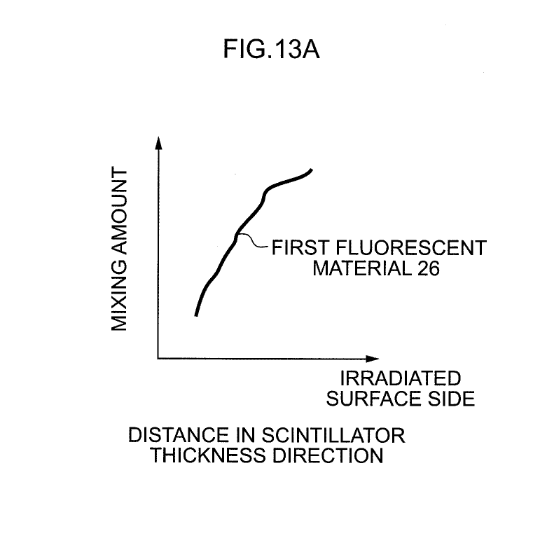

FIG. 12 is a sectional diagram showing the sectional structure of a radiation detector 600 according to the fifth exemplary embodiment of the invention.

As shown in FIG. 12, the structure of the radiation detector 600 according to the fifth exemplary embodiment of the invention is similar to the structure shown in FIG. 11 described in the fourth exemplary embodiment, but the material of the first photoelectric conversion layer differs from the fourth exemplary embodiment.

Specifically, in the radiation detector 600 according to the fifth exemplary embodiment of the invention, a first photoelectric conversion layer 602 is constituted with an inorganic material such as non-crystalline silicon or the like whose radiation X absorption wavelength range is wider and broader than that of the organic material that constitutes the first photoelectric conversion layer 510 in the fourth exemplary embodiment. A color filter 604 is disposed between the second photoelectric conversion layer 506 and the TFT board 508 and absorbs light emitted from the one scintillator layer 502. Because the range of wavelengths of the radiation X absorbed by the inorganic material constituting the first photoelectric conversion layer 602 is wide, there is a possibility of light emitted from the one scintillator layer 502 being absorbed. Accordingly, the color filter 604 is provided to prevent this.

Operation

According to the above constitution of the radiation detector 600 according to the fifth exemplary embodiment of the invention, in addition to the operation of the fourth exemplary embodiment, because the first photoelectric conversion layer 602 is constituted by the inorganic material with a wide and broad radiation X absorption wavelength range, scope for selection of the first fluorescent material 503 that constitutes the other scintillator layer 504 may be widened.

### Variant Example

The present invention has been described in detail using the particular first to fifth exemplary embodiments, but the present invention is not limited to these embodiments. It will be clear to practitioners skilled in the art that numerous other embodiments are possible within the technical scope of the invention. For example, the plural exemplary embodiments described above may be embodied in suitable combinations, and the variant example described below may be combined as appropriate.

For example, in the first exemplary embodiment a case is described in which the scintillator layer 24 is constituted with the first fluorescent material 26 and the second fluorescent material 28 being mixed uniformly. However, a mixing ratio of the first fluorescent material 26 and the second fluorescent material 28 may be varied between the radiation X irradiated surface 300 side and the non-irradiated face side of the scintillator layer 24.

As an example of the mixing ratio being varied, as illustrated in FIG. 13A, more of the first fluorescent material 26 than the second fluorescent material 28 is mixed at the first photoelectric conversion layer 30 side (the radiation X irradiated surface 300 side) of the scintillator layer 24, and more of the second fluorescent material 28 than the first fluorescent material 26 is mixed at the second photoelectric conversion layer 34 side of the scintillator layer 24.

According to this constitution, because more of the first fluorescent material 26 than of the second fluorescent material 28 is mixed in a scintillator region at the first photoelectric conversion layer 30 side of the scintillator layer 24, absorption amounts of the low-energy radiation X1 are larger, as illustrated in FIG. 13B, and the first wavelength light 26A is primarily emitted. Meanwhile, because more of the second fluorescent material 28 than of the first fluorescent material 26 is mixed in a scintillator region at the second photoelectric conversion layer 34 side of the scintillator layer 24, absorption amounts of the high-energy radiation X2 are larger, as illustrated in FIG. 13B, and the second wavelength light 28A is primarily emitted.

Therefore, received light amounts of the first wavelength light 26A at the first photoelectric conversion layer 30 are larger than received light amounts of the second wavelength light 28A by amounts corresponding to the amount by which the distance from the scintillator region at the first photoelectric conversion layer 30 side that primarily emits the first wavelength light 26A is shorter than the distance from the scintillator region at the second photoelectric conversion layer 34 side that primarily emits the second wavelength light 28A, and a low-voltage image with little noise may be obtained.

Meanwhile, received light amounts of the second wavelength light 28A at the second photoelectric conversion layer 34 are larger than received light amounts of the first wavelength light 26A by amounts corresponding to the amount by which the distance from the scintillator region at the second photoelectric conversion layer 34 side that primarily emits the second wavelength light 28A is shorter than the distance from the scintillator region at the first photoelectric conversion layer 30 side that primarily emits the first wavelength light 26A, and a high-voltage image with little noise may be obtained.

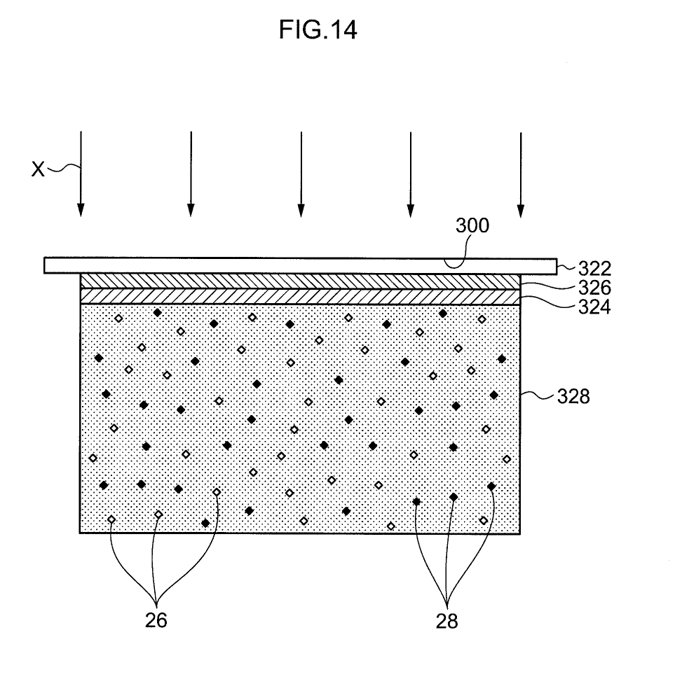

In the second exemplary embodiment, as shown in FIG. 9, a case is described in which the first photoelectric conversion layer 324, the second photoelectric conversion layer 326 and the scintillator layer 328 are layered in this order from the TFT board 322 that serves as the radiation X irradiated surface 300. However, as shown in FIG. 14, the second photoelectric conversion layer 326, the first photoelectric conversion layer 324 and the scintillator layer 328 may be layered in this order from the TFT board 322. In this structure, the distance between the scintillator layer 328 and the first photoelectric conversion layer 324 is shorter by an amount corresponding to the second photoelectric conversion layer 326 not being interposed therebetween. Thus, received light amounts of the light whose peak is the first wavelength 26A that are received at the first photoelectric conversion layer 324 may be increased.

In the first and third exemplary embodiments, cases are described in which the two TFT boards 32 and 36 are provided. However, a single board that has the functionality of the TFT boards 32 and 36 may be provided. Similarly, in the second exemplary embodiment a case in which the TFT board 322 is provided is described, but the TFT board 322 may be divided into a TFT board for the first photoelectric conversion layer 324 and a TFT board for the second photoelectric conversion layer 326 and these two boards may be provided.

In FIG. 7, the first signal lines 126A and the second signal lines 126B are connected to the single signal detection circuit 200. However, two of the signal detection circuit 200 may be provided, and the first signal lines 126A and the second signal lines 126B connected to the different signal detection circuits 200. Accordingly, a signal detection circuit used in a conventional light detection board that detects a single radiation image may be used.

In the first exemplary embodiment, a case is described in which the radiation detector 20 that detects radiation X passing through the patient 14 and the control board 22 are provided inside the casing 16 in this order from the irradiated surface 18 side of the casing 16, on which the radiation X is irradiated. However, a grid, the radiation detector 20 and a lead plate may be accommodated inside the casing 16, in this order from the irradiated surface 18 side on which the radiation X is irradiated. The grid eliminates scattering of the radiation X that is caused as the radiation passes through the patient 14, and the lead plate absorbs back scattering of the radiation X.

In the first exemplary embodiment, a case in which the shape of the casing 16 is a rectangular flat plate is described, but this is not particularly limiting. For example, the shape in a front view may be a square shape, a round shape or the like.

In the first exemplary embodiment, a case is described in which the control board 22 is formed as a single board, but the present invention is not limited to this exemplary embodiment. The control board 22 may be divided into a plural number of boards for respective functions. Furthermore, a case is described in which the control board 22 is disposed beside the radiation detector 20 in a vertical direction (the thickness direction of the casing 16). However, the control board 22 may be disposed beside the radiation detector 20 in a horizontal direction.

The radiation X is not limited just to X-rays, and may be alpha rays, beta rays, gamma rays, electron beams, ultraviolet rays or the like.

Cases have been described in which the radiation image capturing device is the portable electronic cassette 10. However, the radiation image capturing device may be a large radiation image capturing device that is not portable.

Apart from in the second exemplary embodiment, the direction of irradiation of the radiation X may be the opposite direction. For example, in the first exemplary embodiment the TFT board 32 serves as the radiation X irradiated surface 300, but the TFT board 36 may serve as the radiation X irradiated surface.

The disclosures of Japanese Patent Application No. 2010-167489 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

What is claimed is:

1. A radiation detector comprising:
a scintillator layer in which a first fluorescent material and a second fluorescent material are in separate layers or are mixed in a single layer, the first fluorescent material responding primarily to radiation of a first energy in irradiated radiation and converting the radiation to light of a first wavelength, and the second fluorescent material responding primarily to radiation of a second energy that is different from the first energy in the irradiated radiation and converting the radiation to light of a second wavelength that is different from the first wavelength;
a first photoelectric conversion layer that is disposed at a side of irradiation of the radiation relative to the scintillator layer including the first fluorescent material, the first photoelectric conversion layer being constituted with one of a first organic material and an inorganic material with a wider radiation absorption wavelength range than the first organic material, and the first photoelectric conversion layer absorbing at least light of the first wavelength and converting the light to charges;
a second photoelectric conversion layer that is constituted with a second organic material that is different from the first organic material, the second photoelectric conversion layer absorbing more of light of the second wavelength than of light of the first wavelength and converting the light to charges; and
one board or two boards, at which transistors that read out charges generated at the first photoelectric conversion layer and the second photoelectric conversion layer are formed, wherein
the scintillator layer, the first photoelectric conversion layer, the second photoelectric conversion layer, and the one board or two boards are layered.

2. The radiation detector according to claim 1, wherein
the first energy is a smaller energy than the second energy, and
the first photoelectric conversion layer is constituted with the first organic material, absorbs more of light of the first wavelength than of light of the second wavelength, and converts the light to charges.

3. The radiation detector according to claim 2, wherein
the scintillator layer is a single layer in which the first fluorescent material and the second fluorescent material are mixed,
the boards are constituted by two boards, a first board of which reads out charges generated at the first photoelectric conversion layer and a second board of which reads out charges generated at the second photoelectric conversion layer, the one board serving as a radiation irradiated surface, and,
from a side at which the first board is disposed, the first photoelectric conversion layer, the scintillator layer, the second photoelectric conversion layer and the second board are layered in this order.

4. The radiation detector according to claim 3, wherein
more of the first fluorescent material than of the second fluorescent material is mixed at the first photoelectric conversion layer side of the scintillator layer, and
more of the second fluorescent material than of the first fluorescent material is mixed at the second photoelectric conversion layer side of the scintillator layer.

5. The radiation detector according to claim 2, wherein
the boards are constituted by two boards, a first board of which reads out charges generated at the first photoelectric conversion layer and a second board of which reads out charges generated at the second photoelectric conversion layer, the first board serving as a radiation irradiated surface,
the scintillator layer is constituted by separate layers, a first scintillator layer of the separate layers being constituted with the first fluorescent material and a second scintillator layer of the separate layers being constituted with the second fluorescent material, and,
from a side at which the first board is disposed, the first photoelectric conversion layer, the first scintillator layer, the second scintillator layer, the second photoelectric conversion layer and the second board are layered in this order.

6. The radiation detector according to claim 2, wherein
the scintillator layer is a single layer in which the first fluorescent material and the second fluorescent material are mixed,
the board is a radiation irradiated surface, and,
from a side at which the board is disposed, the first photoelectric conversion layer, the second photoelectric conversion layer and the scintillator layer are layered in this order, or the second photoelectric conversion layer, the first photoelectric conversion layer and the scintillator layer are layered in this order.

7. The radiation detector according to claim 2, wherein
an active layer of the transistors is constituted with a non-crystalline oxide, and
the board is constituted with a plastic resin.

8. The radiation detector according to claim 1, wherein
the first energy is greater than the second energy,
the first photoelectric conversion layer is constituted with the first organic material, absorbs more of light of the first wavelength than of light of the second wavelength, and converts the light to charges,
the scintillator layer is constituted by separate layers,
a first scintillator layer of the separate layers is constituted with the second fluorescent material and serves as a radiation irradiated surface,
a second scintillator layer of the separate layers is constituted with the first fluorescent material, and,
from a side at which the first scintillator layer is disposed, the second photoelectric conversion layer, the board, the first photoelectric conversion layer, and the second scintillator layer are layered in this order.

9. The radiation detector according to claim 8, further comprising a color filter disposed one of between the first photoelectric conversion layer and the board and between the second photoelectric conversion layer and the board, the color filter absorbing light from one of the first scintillator layer and the second scintillator layer.

10. The radiation detector according to claim 8, wherein
an active layer of the transistors is constituted with a non-crystalline oxide, and
the board is constituted with a plastic resin.

11. The radiation detector according to claim 1, wherein
the first energy is greater than the second energy,
the first photoelectric conversion layer is constituted with the inorganic material,
the scintillator layer is constituted by separate layers,
a first scintillator layer of the separate layers is constituted with the second fluorescent material and serves as a radiation irradiated surface,
a second scintillator layer of the separate layers is constituted with the first fluorescent material, and,
from a side at which the first scintillator layer is disposed, the second photoelectric conversion layer, the board, the first photoelectric conversion layer, and the second scintillator layer are layered in this order.

12. The radiation detector according to claim 9, further comprising a color filter disposed one of between the first photoelectric conversion layer and the board and between the second photoelectric conversion layer and the board, the color filter absorbing light from one of the first scintillator layer and the second scintillator layer.

13. The radiation detector according to claim 1, wherein
the first photoelectric conversion layer transmits light of the second wavelength and absorbs light of the first wavelength, and
the second photoelectric conversion layer transmits light of the first wavelength and absorbs light of the second wavelength.

14. The radiation detector according to of claim 1, wherein the first wavelength is a wavelength of blue light and the second wavelength is a wavelength of green light.
